(19) United States
(12) Patent Application Publication
(10) Pub. No.: US 2024/0059855 A1
(43) Pub. Date: Feb. 22, 2024

(54) FLAME-RETARDANT SOUNDPROOF MATERIAL FOR VEHICLES

(71) Applicants: TOKAI CHEMICAL INDUSTRIES, LTD., Gifu (JP); Sumitomo Riko Company Limited, Aichi (JP)

(72) Inventors: Yasuo Suzuki, Gifu (JP); Masahito Kanada, Gifu (JP); Hiroki Taguchi, Gifu (JP); Masaru Sato, Gifu (JP); Hiroyuki Kondo, Aichi (JP); Kenichiro Ito, Aichi (JP); Junki Owaki, Aichi (JP)

(73) Assignees: TOKAI CHEMICAL INDUSTRIES, LTD., Gifu (JP); Sumitomo Riko Company Limited, Aichi (JP)

(21) Appl. No.: 18/500,137

(22) Filed: Nov. 2, 2023

Related U.S. Application Data
(63) Continuation of application No. PCT/JP2022/009741, filed on Mar. 7, 2022.

(30) Foreign Application Priority Data
Jul. 26, 2021 (JP) 2021-121824

(51) Int. Cl. C08J 9/228; C08K 3/04; C08G 18/48

(52) U.S. Cl. CPC C08J 9/228; C08K 3/042; C08G 18/48; C08K 2201/005; C08J 2203/00; C08J 2375/04

(57) ABSTRACT

A flame-retardant soundproof material for vehicles includes a polyurethane foam obtained by foam-molding a urethane resin composition. The urethane resin composition contains an isocyanate component (A), a polyol component (B), and an expandable graphite (C). The isocyanate component (A) includes a mixture of 2,4′-MDI and 4,4′-MDI, and one or more modified forms selected from carbodiimide modified forms and uretonimine modified forms of at least one of 2,4′-MDI and 4,4′-MDI. The content of the one or more modified forms in the urethane resin composition is 5.0 mass % to 8.8 mass %. The polyol component (B) includes a polyether polyol as a main constituent. The expandable graphite (C) has an expansion initiation temperature of 170° C. to 200° C., an expansion ratio of 10 or more at 250° C., and a content of 8 mass % to 20 mass % in the urethane resin composition.

### CROSS-REFERENCE TO RELATED APPLICATIONS

This application is a Continuation of PCT International Application No. PCT/JP2022/009741, filed on Mar. 7, 2022, which claims priority benefits of Japanese Patent Application No. 2021-121824, filed on Jul. 26, 2021. Each of the above applications is hereby expressly incorporated by reference, in its entirety, into the present application.

### TECHNICAL FIELD

This disclosure relates to a flame-retardant soundproof material for vehicles that is excellent in soundproofing and flame retardancy.

### DESCRIPTION OF RELATED ART

In a vehicle such as an automobile, various measures are taken to reduce noise leaking out of the vehicle and into interior of the vehicle. For example, in an engine room of a vehicle, soundproof covers such as an engine cover, a side cover, and an oil pan cover are arranged around the engine to reduce the noise emitted from the engine as a noise source. In addition, a cushioning material is often disposed between the engine and the parts arranged close thereto. Foams such polyurethane foams, which are lightweight and have high vibration absorptivity, are used for these soundproof covers and cushioning materials, but in a use environment such as an engine room, a foam needs to have high flame retardancy in addition to soundproofing property.

For example, Patent Literature 1 describes a polyurethane foam comprising the reaction product of a reactive-to-isocyanate component comprising a polyether polyol and an expandable graphite and an isocyanate component comprising an isocyanate-containing compound and a non-reactive phosphorus compound, the polyurethane foam having a flame retardancy of V-0 level of UL94 standard. Further, Patent Literature 2 describes a polyurethane foam for vehicles that contains expandable graphite and a hydrate of an inorganic compound.

The polyurethane foam described in Patent Literature 1 contains an expandable graphite and a non-reactive phosphorus compound as flame retardants. If the amount of powdery expandable graphite is increased to improve flame retardancy, the polyurethane foam becomes hard, lowering the deformation followability. As a result, the soundproofing property degrades.

By using a non-reactive phosphorus compound together as a flame retardant, it is possible to reduce the blending amount of expandable graphite. However, for the non-reactive phosphorus compound is liquid (para. of Patent Literature 1), there is a risk that the polyurethane foam will become too soft with its blending. Furthermore, with investigation of the Inventors, it has been confirmed that a closed skin layer is difficult to form. Such polyurethane foams are not suitable for applications such as engine covers that require shape retention and design.

The polyurethane foam described in Patent Literature 2 contain an expandable graphite as a flame retardant and a hydrate of an inorganic compound as an anti-coloring agent. Not only the expandable graphite but also the hydrate of the inorganic compound are powders (para. of Patent Literature 2). When powder is used, the producing equipment is likely to wear out, and maintenance such as clogging clearing is also required, which may reduce productivity. Further, as the blending amount of powder increases, as described above, the polyurethane foam becomes hard lowering the deformation followability, and also becomes difficult to be reduced in weight. For this reason, when powder is blended, it is desired to use an amount as small as possible. Patent Literature 2 describes in its examples that a polyurethane foam containing an expandable graphite and a hydrate of an inorganic compound had a level of low flammability that passes a horizontal burning test according to the Federal Motor Vehicle Safety Standard No. 302 (FMVSS 302). However, whether the polyurethane foam had a flame retardancy of V-0 level of UL94 standard is unknown. Patent Literature 2 describes in paragraph that a phosphorus-based flame retardant may be blended as a flame retardant, but blending a liquid causes softening, thus lowering the shape retainability and designability, as mentioned above.

As described above, Patent Literatures 1 and 2 describe polyurethane foams containing expandable graphite, but there is still room for further investigation on the expandable graphite and the isocyanate component in the raw material, and, for use as flame-retardant soundproof materials for vehicles, it is required to further improve the flame retardancy while ensuring the soundproofing property.

### PATENT LITERATURES

Patent Literature 1: JP2016510837A
Patent Literature 2: JP2008138032A

### SUMMARY

Accordingly, the disclosure provides a flame-retardant soundproof material for vehicles that comprises a polyurethane foam obtained by foam-molding a urethane resin composition and has a flame retardancy of V-0 level of UL94 standard in either of a normal condition and a condition after heat aging at 150° C. for 168 hours. The urethane resin composition contains an isocyanate component (A), a polyol component (B), and an expandable graphite (C). The isocyanate component (A) comprises a mixture of 2,4′-diphenylmethane diisocyanate and 4,4′-diphenylmethane diisocyanate, and one or more modified forms selected from carbodiimide modified forms and uretonimine modified forms of at least one of 2,4′-diphenylmethane diisocyanate and 4,4′-diphenylmethane diisocyanate, wherein the content of the one or more modified forms is 5.0 mass % to 8.8 mass % based on 100 mass % of the entire urethane resin composition. The polyol component (B) comprises a polyether polyol as a main constituent. The expandable graphite (C) has an expansion starting temperature of 170° C. to 200° C., an expansion ratio of 10 or more at 250° C., and a content of 8 mass % to 20 mass % based on 100 mass % of the entire urethane resin composition. The breaking elongation of the polyurethane foam is 70% or more.

In the flame-retardant soundproof material for vehicles of the disclosure, by limiting the isocyanate component used as a raw material to a specific component and limiting the properties of the expandable graphite and optimizing its content to a relatively low range, the polyurethane foam makes both soundproofing property and flame retardancy. The flame retardancy of the polyurethane foam is determined by performing a vertical burning test of UL94 standard. In the vertical burning test of UL94 standard, if all of the following five criteria are satisfied, the flame retardancy is determined to be V-0 level. Criterion (1) is that the sample does not burn for longer than 10 seconds in either of two flame contacts. Criterion (2) is that the total burning time for each of five samples with two flame contacts does not exceed 50 seconds. Criterion (3) is that no sample burns up to the position of the fixing clamp. Criterion (4) is that no sample drips burning particles that ignite cotton placed underneath the sample. Criterion (5) is that the sample does not continue to glow red for longer than 30 seconds after the second flame contact. The polyurethane foam making the flame-retardant soundproof material for vehicles of the disclosure (hereinafter referred to as “the polyurethane foam of the disclosure”) has excellent flame retardancy of V-0 level of UL94 standard not only in a normal condition, that is, the same condition as it was manufactured, but also in a condition after heat aging at 150° C. for 168 hours.

As the isocyanate component (A), a mixture of 2,4′-diphenylmethane diisocyanate and 4,4′-diphenylmethane diisocyanate, and one or more modified forms selected from carbodiimide modified forms and uretonimine modified forms of at least one of 2,4′-diphenylmethane diisocyanate and 4,4′-diphenylmethane diisocyanate, are used. Hereafter, if appropriate, diphenylmethane diisocyanate is referred to as “MDI”, 2,4′-diphenylmethane diisocyanate is referred to as “2,4′-MDI”, and 4,4′-diphenylmethane diisocyanate is referred to as “4,4′-MDI”. By using both the mixtures and the modified form(s), the flame retardancy of the polyurethane foam can be enhanced. That is, as the modified forms are difficult to thermally decompose, the molecules are difficult to be cut during heating, so generation of combustible gas is suppressed. As a result, the flame retardancy is improved not only in the normal condition but also after heat aging. In order to exhibit the flame retardancy improving effect of the modified form(s), the content thereof should be 5.0 mass % or more based on 100 mass % of the entire urethane resin composition. Conversely, if the content of the modified form(s) is too high, it becomes difficult to form the polyurethane foam. For this reason, the content of the modified form(s) is set to 8.8 mass % or less based on 100 mass % of the entire urethane resin composition.

The modified form is produced by a carbodiimidation reaction in which the NCO groups of two MDI molecules are condensed together, and further by a uretonimination reaction in which one MDI molecule is added to the resulting carbodiimidation product (carbodiimide modified form). As a secondary reaction of the carbodiimidation reaction of MDI, a uretonimine product (uretonimine modified form) is also produced through a chemical equilibrium reaction. In general, it is considered that most reaction products are uretonimine modified forms with progress of the carbodiimidation reaction. In this specification, the modified form is referred to as “one or more modified forms selected from carbodiimide modified forms and uretonimine modified forms”, covering all the products obtained by the carbodiimidation reaction of either or both of 2,4′-MDI and 4,4′-MDI. It can also be described as “carbodiimide modified form(s) and/or uretonimine modified form(s)”. A carbodiimide modified form or a uretonimine modified form can be obtained by a known method, for example, reacting a single-component MDI or a multi-component MDI containing isomers using a catalyst such as an organic phosphate ester.

The expandable graphite (C) is obtained by inserting a substance generating gas when heated between layers of flake graphite. When the expandable graphite is heated, the interlayer widens and expands due to the gas generated from the interlayer substance. Then, a solid phase that is stable against heat and chemicals is formed, which serves as a heat insulating layer and prevents heat transfer, resulting in a flame retardation effect. As the expandable graphite, one having an expansion start temperature of 170° C. to 200° C. and an expansion ratio of 10 or more at 250° C. is used. Because the expansion start temperature is 170° C. to 200° C., expansion does not start even if heat aging is performed at 150° C. As described above, for the molecules are difficult to be cleaved when heated, the thermal decomposition temperature of the polyurethane foam of this disclosure is high, for example, exceeds 250° C. Therefore, when the expansion ratio at 250° C. is 10 or more, the flame retardation effect can be exhibited more easily. In order to sufficiently exhibit the flame retardation effect, the content of the expandable graphite is set to 8 mass % or more based on 100 mass % of the entire urethane resin composition. In addition, considering the hardness, elongation, and weight reduction, etc. of the polyurethane foam, it is desired that the content of the expandable graphite is as small as possible. Hence, the content of the expandable graphite is set to 20 mass % or less based on 100 mass % of the entire urethane resin composition. Thereby, a polyurethane foam with a breaking elongation of 70% or more can be realized. As a result, the polyurethane foam of this disclosure is good in deformation following property due to vibration, and is excellent in soundproofing property.

As described above, with the flame-retardant soundproof material for vehicles of this disclosure, deterioration of soundproofing property can be avoided even if the flame retardancy of the polyurethane foam is raised. Also, the polyurethane foam has good moldability, and can be applied to applications requiring shape retention and designability.

### DESCRIPTION OF THE EMBODIMENTS

Hereinafter, embodiments of the flame-retardant soundproof material for vehicles of this disclosure will be described. It should be noted that the embodiments of this disclosure are not limited to the following embodiments, and can be implemented in various modifications and improvements that can be made by one of ordinary skill in the art.

In the flame-retardant soundproof material for vehicles of the disclosure, configurations other than the polyurethane foam is not particularly limited. The flame-retardant soundproof material for vehicles of this disclosure may be composed of the polyurethane foam only, or be composed of a combination of the polyurethane foam and other members. For example, as the flame-retardant soundproof material for vehicles of this disclosure is embodied in an engine cover, the engine cover may be a single-layer structure of the polyurethane foam, or a multilayer structure having a soundproof layer made of the polyurethane foam and a skin layer covering the surface thereof. In addition, the “vehicle” as an application of this disclosure includes not only automobiles but also airplanes, trains, and so on.

<Components of Polyurethane Foam>

The polyurethane foam of this disclosure is a foam-molded product of a urethane resin composition containing an isocyanate component (A), a polyol component (B), and an expandable graphite (C).

Isocyanate Component (A)

The isocyanate component includes a mixture of 2,4′-MDI and 4,4′-MDI and one or more modified forms selected from carbodiimide modified forms and uretonimine modified forms of at least one of 2,4′-MDI and 4,4′-MDI. The content ratio of 2,4′-MDI and 4,4′-MDI in the mixture may be appropriately determined in consideration of breaking elongation, moldability, and so on. As mentioned above, the scope of the modified form(s) includes the product obtained by the carbodiimidation reaction of 2,4′-MDI or 4,4′-MDI, and the product obtained by the carbodiimidation reaction of 2,4′-MDI and 4,4′-MDI. When the entire urethane resin composition is 100 mass %, from the viewpoint of increasing the thermal decomposition temperature of the polyurethane foam and suppressing generation of flammable gas during heating to raise flame retardancy, the content of the modified form(s) is preferably 5.0 mass % or more, more preferably 5.3 mass % or more. On the other hand, from the viewpoint of facilitating the formation of the polyurethane foam, the content is preferably 8.8 mass % or less, more preferably 8.5 mass % or less.

The isocyanate component may include a prepolymer of obtained by reacting MDI and a polyol in addition to the mixture and the modified form(s). When the prepolymer is present, as compared to when the prepolymer is absent, the viscosity of the urethane resin composition becomes higher and the moldability is improved. The content of the prepolymer is preferably 0.1 mass % to 5 mass % based on 100 mass % of the entire urethane resin composition. For example, reacting MDI with a trifunctional polyol results in a prepolymer having three urethane bonds. Among them, an isocyanate-terminated prepolymer obtained by reacting MDI with a bifunctional polyether polyol is preferred. Here, a polyether polyol having a molecular weight of about 1000 is taken as an example of the bifunctional polyether polyol.

Although the mixture, the modified form(s), and the prepolymer have been described as constituents of the isocyanate component, inclusion of isocyanate compound(s) other than these constituents is not excluded if only the polyurethane foam of this disclosure can be realized without inhibiting the effects of these constituents. An example of such isocyanate compound is a polymeric MDI (polynuclear form) having three or more isocyanate groups and three or more benzene rings per molecule. However, containing a polymeric MDI is not preferred as the breaking elongation may decrease and the flame retardancy may degrade.

Polyol Component (B)

As polyol components, polyhydric hydroxy compounds, polyether polyols, polyester polyols, polyether polyamines, polyester polyamines, alkylene polyols, urea-dispersed polyols, melamine-modified polyols, polycarbonate polyols, acrylic polyols, polybutadiene polyols, and phenol-modified polyols, etc. are known. In producing the polyurethane foam of this disclosure, a polyether polyol is used as the main constituent of the polyol component (B). The “main constituent” means a constituent that takes for 60 mass % or more based on 100 mass % of the total polyol component. Therefore, as the polyol component, it is possible to use only a polyether polyol, or to use a polyether polyol as a main constituent in combination with other polyol(s) as appropriate. For example, from the viewpoint of improving the moldability, it is desired to use a polyester polyol in combination.

The number of functional groups in the polyether polyol is preferably 2 to 8. When the number of functional groups is less than 2, the chain reaction with the isocyanate component is likely to be interrupted, making it difficult to form a polymer, so that the moldability degrades. When the number of functional groups exceeds 8, elongation of the polyurethane foam decreases, resulting in decrease in soundproofing property. Moreover, the mass average molecular weight of the polyether polyol is desirably 1000 to 10000. When the mass average molecular weight is less than 1000, the polyurethane foam becomes hard, leading to decrease in soundproofing property. When the mass average molecular weight exceeds 10000, viscosity of the urethane resin composition becomes too high, making the reaction with the isocyanate component and the foaming operations difficult.

Expandable Graphite (C)

An expandable graphite is obtained by inserting, between layers of graphite, a substance that generates gas when heated, and expands at a predetermined temperature depending on the kind of the interlayer substance when heated. In producing the polyurethane foam of this disclosure, an expandable graphite having an expansion start temperature of 170° C. to 200° C. and an expansion ratio of 10 or more at 250° C. is used. Examples of the interlayer substance are sulfuric acid, nitric acid, sodium nitrate, and potassium permanganate, etc., but sulfuric acid is preferred in consideration of expansion start temperature and expansion ratio, etc. Moreover, from the viewpoint of reducing influence on hardness and elongation, etc. of the polyurethane foam, the particle size of the expandable graphite by means of sieving is desirably 45 μm to 1000 μm. In this specification, the sieving of expandable graphite is performed using a metal mesh sieve according to JIS Z8801-1:2019.

Upon investigation by the Inventors, it was confirmed that in an expandable graphite, as the particle size increases, the expansion ratio at high temperature increases. Therefore, it is considered that the larger the particle size of the expandable graphite is, the larger the heat insulating layer is formed and the flame retardation effect is improved. From the viewpoint of enhancing the flame retardation effect of the expandable graphite, it is desired to sieve the expandable graphite and use particles with a particle size of 250 μm or more. More preferably, it is desired to use particles with a particle size of 355 μm or more, and further preferably, particles with a particle size of 425 μm or more.

When the entire urethane resin composition is 100 mass %, the content of the expandable graphite is 8 mass % or more, preferably 13.5 mass % or more, and more preferably 15.0 mass %, from the viewpoint of fully exhibiting the flame retardation effect. On the other hand, from the viewpoint of keeping the content as low as possible in consideration of hardness, elongation, and weight reduction, etc. of the polyurethane foam, it is desired that the content is 20 mass % or less, and more preferably 18.0 mass % or less. As mentioned above, as the particle size of expandable graphite increases, the expansion ratio at high temperatures increases, so a high flame retardation effect can be exhibited with a smaller amount of expandable graphite. For example, when the particle size of the expandable graphite is 250 μm or more, the content of the expandable graphite can be 10 mass % or less.

Other Components (D)

In addition to the above components (A) to (C), the urethane resin composition may also contain known materials used in producing polyurethane foam, such as a catalyst, a foaming agent, a foam stabilizer, a crosslinking agent, an antistatic agent, a viscosity reducer, a stabilizer, a fillers, and a colorant, etc. as appropriate. Among them, examples of the catalyst includes: amine catalysts such as tetramethylethylenediamine, bis(2-dimethylaminoethyl)ether, triethylenediamine, triethylamine, N,N,N′,N′-tetramethylhexane-1,6-diamine, N,N,N′,N″,N″-pentamethyl-diethylenetriamine, N,N,N′,N″,N′″,N′″-hexamethyltriethylene-tetraamine, and N,N′,N′-trimethylaminoethylpiperazine, etc.; acids such as formic acid, citric acid, butyric acid, and 2-ethylhexanoic acid, etc.; and organometallic catalysts such as tin laurate and tin octoate. As the foaming agent, water is preferred, and its examples other than water include methylene chloride and CO₂ gas. As the foam stabilizer, a silicone-based foam stabilizer is suitable. As the cross-linking agent, diethylene glycol, triethanolamine, and diethanolamine, etc. are suitable.

Further, the polyurethane foam of this disclosure achieves desired flame retardancy mainly by limiting the isocyanate component and the expandable graphite. Therefore, apart from the expandable graphite, there is no need to use conventionally used flame retardants such as phosphorus-based, halogen-based, and metal hydroxide-based flame retardants. Since the polyurethane foam contains no flame retardant other than expandable graphite, it has excellent shape retainability and designability. Therefore, the polyurethane foam alone can constitute a cover member exposed to the outside as a flame-retardant soundproof material for vehicles.

<Characteristics of Polyurethane Foam>

(1) Breaking Elongation

The breaking elongation of the polyurethane foam of this disclosure is 70% or more. The breaking elongation has the same meaning as the elongation at break (Eb) defined in ASTM D 3574-11, and may be measured according to the measurement method of the same standard. A dumbbell-shaped ASTM D 3574 (thickness of the parallel part is 12.7 mm) is used as the test piece, and the test speed is 500 mm/min.

(2) Flame Retardancy

The flame retardancy of the polyurethane foam of this disclosure is at the V-0 level of the UL94 standard in either of a normal condition and a condition after heat aging at 150° C. for 168 hours. Furthermore, it is desired to maintain the flame retardancy at the V-0 level of the UL94 standard even after heat aging at 150° C. for 336 hours. Heat aging can be carried out by placing the sample in an oven at 150° C. and holding it for a predetermined period of time. As mentioned above, the flame retardancy is determined by performing a vertical combustion test according to the UL94 standard.

<Production Method of Polyurethane Foam>

The polyurethane foam of this disclosure is produced by foam-molding the urethane resin composition. First, the expandable graphite and other components such as a catalyst, a foaming agent and a foam stabilizer are mixed in advance with a polyol component to prepare a premix polyol. Next, the isocyanate component is mixed with the above prepared premix polyol, and foam-molding is carried out. For example, the premixed polyol and the isocyanate component may be mechanically stirred using a propeller or the like, and then injected into a mold for foam molding. Or, it is possible to inject the premixed polyol and the isocyanate component at high pressure using a high-pressure jet injection foaming device or the like and make the two components collided and mixed to be foam-molded (impingement stirring method). The impingement stifling method allows continuous production, and is therefore suitable for mass production. Moreover, when the impingement stirring method is used, compared with the mechanical stirring method, the process of cleaning the container required for mixing becomes unnecessary, and the yield is improved. Therefore, the production cost can be reduced.

It is desired to blend the premixed polyol and the isocyanate component such that the isocyanate index (equivalent ratio of isocyanate group/active hydrogen group) is 1.0 to 1.5, preferably 1.0 to 1.2. If the isocyanate index is less than 1.0, the flame retardancy decreases.

On the other hand, if the isocyanate index exceeds 1.5, the moldability decreases.

### EXAMPLES

Next, this disclosure will be described in more details with Examples provided below.

### <Production of Polyurethane Foam>

First, an expandable graphite (C) is appropriately added to 100 mass parts of a polyether polyol (SBU Polyol 0265 produced by Sumika Covestro Urethane Co., Ltd.; average molecular weight: 6000; number of functional groups: 3) as the polyol component (B), and 3.2 mass parts of water as a foaming agent, 0.9 mass part of an amine catalyst, 0.3 mass part of a silicone foam stabilizer, and 1.5 mass part of glycerin as a crosslinking agent were added and mixed to prepare a premix polyol. The following four kinds of expandable graphite were used.

### Examples 1 to 4, 7 & 8, and Comparative Examples 1 & 3

“NYACOL Nyagraph 251” produced by NYACOL NANO TECHNOLOGIES, Inc.

Expansion ratio at 250° C.: 10

Expansion start temperature: 170° C.

### Examples 5 & 9-13

“EXP-42S160” produced by Fuji Graphite Works Co., Ltd.

Expansion ratio at 250° C.: 13 (without sieving)

Expansion start temperature: 200° C.

### Example 6

“NYACOL Nyagraph FP” produced by NYACOL NANO TECHNOLOGIES, Inc.

Expansion ratio at 250° C.: 11

Expansion start temperature: 180° C.

### Comparative Example 2

“SYZR 502FP” produced by Shijiazhuang ADT Trading Co., Ltd.

Expansion ratio at 250° C.: 8.5

Expansion start temperature: 175° C.

Among these, for Examples 9 to 13, expandable graphite (“EXP-42S160” produced by Fuji Graphite Works Co., Ltd.) was sieved and only particles with a predetermined particle size or more were used. A stainless steel sieve made by AS ONE Corporation was used for the sieving. The mesh sizes of the sieves used are as follows.

Example 9: mesh size=250 μm (product number: 5-3293-37)

Example 10: mesh size=300 μm (product number: 5-3293-36)

Example 11: mesh size=355 μm (product number: 5-3293-35)

Examples 12 and 13: mesh size=425 μm (product number: 5-3293-34)

100 to 150 g of expandable graphite was put into a sieve, which was attached to a sieving machine (“Sieve Shaker AS200 basic” made by Retsch GmbH) and vibrated for 5 minutes. The particles remaining on the sieve were then used. The expansion ratio of each expandable graphite after sieving at 250° C. was measured to be 14.5.

Next, as the isocyanate component (A), an isocyanate raw material was prepared by appropriately combining a mixture of 2,4′-MDI and 4,4′-MDI, a modified form obtained by carbodiimidating 4,4′-MDI (carbodiimide modified form and/or uretonimine modified form), and a prepolymer obtained by reacting MDI with a difunctional polyether polyol, etc.

Then, the prepared premix polyol and isocyanate raw material were mixed such that the isocyanate index was 1.0 to 1.1 to prepare a urethane resin composition. The respective contents of the isocyanate component and the expandable graphite in the urethane resin composition, and the composition of the isocyanate component (isocyanate raw material) are as shown in Tables 1 and 2 below. Then, the urethane resin composition was injected into the cavity of the mold, the mold was sealed, and foam-molding was carried out at a mold temperature of 50° C. for 5 minutes to obtain a polyurethane foam. Examples 1-13 shown in Tables 1 and 2 are included in the concept the polyurethane foam of this disclosure.

<Evaluation of Polyurethane Foam>

Each produced polyurethane foam was measured for its density, and was evaluated for its breaking elongation, flame retardancy, and soundproofing property.

Evaluation Methods

(1) Breaking Elongation

The breaking elongation (Eb) was measured according to the measuring method specified in ASTM D 3574-11, and the measured value was taken as the breaking elongation of the polyurethane foam. A dumbbell-shaped ASTM D 3574 (thickness of parallel portion: 12.7 mm) was used as the test piece, and the test speed was 500 mm/min.

(2) Flame Retardancy

Strip-shaped test pieces (normal-condition test pieces) having a length of 127 mm, a width of 12.7 mm and a thickness of 7 mm were produced from the polyurethane foam as produced. First, a normal-condition test piece was subjected to a vertical combustion test specified in the UL94 standard. Next, another normal-condition test piece was placed in an oven at 150° C. and held for 168 hours for heat aging (first heat aging), and then the same test was performed. Separately, another normal-condition test piece was heat-aged by placing it in an oven at 150° C. for 336 hours (second heat aging), and then the same test was conducted. The level of flame retardancy of each test piece in the normal condition, after the first heat aging, or after the second heat aging was determined based on the result of the vertical combustion test on the test piece. In addition, in the evaluation column of Table 1 below, “NG” is shown if the product did not meet any of V-0, V-1 and V-2 of UL94 standard.

(3) Soundproofing Property

The cross section of the polyurethane foam was observed using a microscope. If open cells were formed, the polyurethane foam was evaluated as having the desired soundproofing property. In the evaluation rows of Tables 1-2, which will be described later, the case where open cells are formed is indicated as “present” in evaluating the soundproofing property.

Results of Evaluations

Tables 1 and 2 collectively show the components and evaluation results of each urethane resin composition. In the overall evaluation row of Tables 1 and 2, a case having all of three characteristics including (i) a breaking elongation of 70% or more, (ii) the flame retardancies of the test pieces in the normal condition, after the first heat aging, and after the second heat aging, respectively, are all V-0 level, and (iii) having soundproofing property is indicated as “qualified”, and a case insufficient in even one of them is indicated “unqualified”.

TABLE 1

| Components of urethane resin | | | Example | Example | Example | Example | Example | Example |
|---|---|---|---|---|---|---|---|---|
| composition | | | 1 | 2 | 3 | 4 | 5 | 6 |
| Isocyanate | MDI isomers mixture | | 25.3 | 25.3 | 24.9 | 23.6 | 23.6 | 23.6 |
| component | [mass %] | | | | | | | |
| (A) | Modified form of MDI | | 8.8 | 7.0 | 5.3 | 5.0 | 5.0 | 5.0 |
| | [mass %] | | | | | | | |
| | MDI prepolymer | | 0.0 | 2.4 | 4.9 | 4.6 | 4.6 | 4.6 |
| | [mass %] | | | | | | | |
| | Polymeric | | 0.0 | 0.0 | 0.0 | 0.0 | 0.0 | 0.0 |
| | MDI [mass %] | | | | | | | |
| | Content of the entire | | 34.1 | 34.7 | 35.1 | 33.2 | 33.2 | 33.2 |
| | isocyanate component | | | | | | | |
| | [mass %] | | | | | | | |
| Expandable | Expansion start | | 170 | 170 | 170 | 170 | 200 | 180 |
| graphite | temperature [° C.] | | | | | | | |
| (C) | Expansion ratio | | 10 | 10 | 10 | 10 | 13 | 11 |
| | Particle size [μm] | | without sieving | | | | | |
| | Content [mass %] | | 13.5 | 13.5 | 13.5 | 13.5 | 13.5 | 13.5 |
| Evaluation | Density [g/cm³] | | 0.145 | 0.145 | 0.145 | 0.145 | 0.145 | 0.145 |
| | Breaking | | 80 | 80 | 80 | 80 | 80 | 80 |
| | Elongation [%] | | | | | | | |
| | Flame | Normal | V-0 | V-0 | V-0 | V-0 | V-0 | V-0 |
| | retardancy | condition | | | | | | |
| | Vertical | After heat | V-0 | V-0 | V-0 | V-0 | V-0 | V-0 |
| | burning | aging of | | | | | | |
| | test of | 150° C. × | | | | | | |
| | UL94 | 168 hours | | | | | | |
| | | After heat | V-0 | V-0 | V-0 | V-0 | V-0 | V-0 |
| | | aging of | | | | | | |
| | | 150° C. × | | | | | | |
| | | 336 hours | | | | | | |

| | Soundproofing | Present | Present | Present | Present | Present | Present |
|---|---|---|---|---|---|---|---|
| | property | | | | | | |
| | Overall evaluation | Qualified | Qualified | Qualified | Qualified | Qualified | Qualified |
| | (breaking elongation, | | | | | | |
| | flame retardancy, and | | | | | | |
| | soundproofing | | | | | | |
| | property) | | | | | | |
| | | | Example | Example | Comparative | Comparative | Comparative |
| | | | 7 | 8 | Example 1 | Example 2 | Example 3 |
| Isocyanate | MDI isomers mixture | | 23.6 | 23.6 | 22.0 | 23.6 | 0.0 |
| component | [mass %] | | | | | | |
| (A) | Modified form of MDI | | 5.0 | 5.0 | 4.7 | 5.0 | 15.0 |
| | [mass %] | | | | | | |
| | MDI prepolymer | | 4.6 | 4.6 | 4.3 | 4.6 | 0.0 |
| | [mass %] | | | | | | |
| | Polymeric | | 0.0 | 0.0 | 0.0 | 0.0 | 15.0 |
| | MDI [mass %] | | | | | | |
| | Content of the entire | | 33.2 | 33.2 | 31.0 | 33.2 | 30.0 |
| | isocyanate component | | | | | | |
| | [mass %] | | | | | | |
| Expandable | Expansion start | | 170 | 170 | 170 | 175 | 170 |
| graphite | temperature [° C.] | | | | | | |
| (C) | Expansion ratio | | 10 | 10 | 10 | 8.5 | 10 |
| | Particle size [μm] | | without sieving | | | | |
| | Content [mass %] | | 20.0 | 15.0 | 13.5 | 13.5 | 13.5 |
| Evaluation | Density [g/cm³] | | 0.145 | 0.145 | 0.145 | 0.145 | 0.145 |
| | Breaking | | 70 | 80 | 80 | 80 | 60 |
| | Elongation [%] | | | | | | |
| | Flame | Normal | V-0 | V-0 | V-1 | NG | V-0 |
| | retardancy | condition | | | | | |
| | Vertical | After heat | V-0 | V-0 | — | — | NG |
| | burning | aging of | | | | | |
| | test of | 150° C. × | | | | | |
| | UL94 | 168 hours | | | | | |
| | | After heat | V-0 | V-0 | — | — | — |
| | | aging of | | | | | |
| | | 150° C. × | | | | | |
| | | 336 hours | | | | | |

| | | | | | |
|---|---|---|---|---|---|
| Soundproofing property | Present | Present | Present | Present | Present |
| Overall evaluation | Qualified | Qualified | Unqualified | Unqualified | Unqualified |
| (breaking elongation, flame | | | | | |
| retardancy, and | | | | | |
| soundproofing property) | | | | | |

TABLE 2

| | | | Example | Example | Example | Example | Example |
|---|---|---|---|---|---|---|---|
| Components of urethane resin composition | | | 9 | 10 | 11 | 12 | 13 |
| Isocyanate | MDI isomers mixture [mass %] | | 23.6 | 23.6 | 23.6 | 23.6 | 23.6 |
| component | Modified form of MDI [mass %] | | 5.0 | 5.0 | 5.0 | 5.0 | 5.0 |
| (A) | MDI prepolymer [mass %] | | 4.6 | 4.6 | 4.6 | 4.6 | 4.6 |
| | Polymeric MDI [mass %] | | 0.0 | 0.0 | 0.0 | 0.0 | 0.0 |
| | Content of the entire isocyanate | | 33.2 | 33.2 | 33.2 | 33.2 | 33.2 |
| | component [mass %] | | | | | | |
| Expandable | Expansion start temperature [° C.] | | 200 | 200 | 200 | 200 | 200 |
| graphite (C) | Expansion ratio | | 14.5 | 14.5 | 14.5 | 14.5 | 14.5 |
| | Particle size [μm] | | ≥250 | ≥300 | ≥355 | ≥425 | ≥425 |
| | Content [mass %] | | 9.0 | 9.0 | 9.0 | 9.0 | 8.0 |
| Evaluation | Density [g/cm³] | | 0.145 | 0.145 | 0.145 | 0.145 | 0.145 |
| | Breaking Elongation [%] | | 80 | 80 | 80 | 80 | 80 |
| | Flame | Normal condition | V-0 | V-0 | V-0 | V-0 | V-0 |
| | retardancy | After heat aging of | V-0 | V-0 | V-0 | V-0 | V-0 |
| | Vertical | 150° C. × 168 hours | | | | | |
| | burning test | After heat aging of | V-0 | V-0 | V-0 | V-0 | V-0 |
| | of UL94 | 150° C. × 336 hours | | | | | |

| | | | | | |
|---|---|---|---|---|---|
| Soundproofing property | Present | Present | Present | Present | Present |
| Overall evaluation | Qualified | Qualified | Qualified | Qualified | Qualified |
| (breaking elongation, flame | | | | | |
| retardancy, and soundproofing | | | | | |
| property) | | | | | |

As shown in Tables 1 and 2, the polyurethane foams of Examples 1 to 13 had breaking elongations of 70% or more and had desired soundproofing property. In addition, in any of the normal condition, the condition after the first heat aging, and the condition after the second heat aging, they had flame retardancy at the V-0 level of the UL94 standard. That is, the overall evaluation of the polyurethane foam of each of Examples 1 to 13 was “qualified”. Among them, the polyurethane foams of Examples 9 to 13, in which expandable graphite having a particle diameter of a predetermined particle size or more after sieving was used, had the desired flame retardancy even if the content of the expandable graphite was small.

In contrast, in the polyurethane foam of Comparative Example 1, the content of the modified forms in the isocyanate component (A) was small. Therefore, the flame retardancy of the test piece in the normal condition was at the V-1 level and did not reach the V-0 level. For the polyurethane foam of Comparative Example 2, expandable graphite having a small expansion ratio at 250° C. was used. Therefore, the flame retardancy was low and did not fall in any of V-0, V-1 and V-2. The polyurethane foam of Comparative Example 3 contained no mixture in the isocyanate component (A), contained a large proportion of the modified form, and further contained polymeric MDI. Therefore, although the flame retardancy of the test piece in the normal condition was at the V-0 level, the flame retardancy of the test piece after the first heat aging was low and did not fall in any of V-0, V-1 and V-2.

### INDUSTRIAL APPLICABILITY

The flame-retardant soundproof material for vehicles of this disclosure can be used as soundproofing covers such as engine covers, side covers, and oil pan covers, etc. placed around the engine, and can also be used as a cushioning material placed between the engine and parts placed near the engine, in an engine room.

What is claimed is:

1. A flame-retardant soundproof material for vehicles, comprising a polyurethane foam obtained by foam-molding a urethane resin composition, wherein
the urethane resin composition contains an isocyanate component (A), a polyol component (B), and an expandable graphite (C),
the isocyanate component (A) comprises a mixture of 2,4′-diphenylmethane diisocyanate and 4,4′-diphenylmethane diisocyanate, and one or more modified forms selected from carbodiimide modified forms and uretonimine modified forms of at least one of 2,4′-diphenylmethane diisocyanate and 4,4′-diphenylmethane diisocyanate, wherein a content of the one or more modified forms is 5.0 mass % to 8.8 mass % based on 100 mass % of the entire urethane resin composition,
the polyol component (B) comprises a polyether polyol as a main constituent,
the expandable graphite (C) has an expansion starting temperature of 170° C. to 200° C., an expansion ratio of 10 or more at 250° C., and a content of 8 mass % to 20 mass % based on 100 mass % of the entire urethane resin composition,
a breaking elongation of the polyurethane foam is 70% or more, and
the flame-retardant soundproof material for vehicles has a flame retardancy of V-0 level of UL94 standard in either of a normal condition and a condition after heat aging at 150° C. for 168 hours.

2. The flame-retardant soundproof material for vehicles of claim 1, wherein the expandable graphite (C) consists of particles having a particle size of 250 μm or more by means of sieving.

3. The flame-retardant soundproof material for vehicles of claim 1, wherein the expandable graphite (C) consists of particles having a particle size of 355 μm or more by means of sieving.

4. The flame-retardant soundproof material for vehicles of claim 1, wherein the expandable graphite (C) consists of particles having a particle size of 425 μm or more by means of sieving.

5. The flame-retardant soundproof material for vehicles of claim 1, wherein the expandable graphite (C) has a content of 13.5 mass % or more based on 100 mass % of the entire urethane resin composition is.

6. The flame-retardant soundproof material for vehicles of claim 1, wherein the isocyanate component (A) further comprises a prepolymer obtained by reacting diphenylmethane diisocyanate with a polyol.

7. The flame-retardant soundproof material for vehicles of claim 1, wherein the polyether polyol in the polyol component (B) has a number of functional groups of 2 to 8 and a mass average molecular weight of 1000 to 10000.

8. The flame-retardant soundproof material for vehicles of claim 1, which has a flame retardancy of V-0 level of UL94 standard after heat aging at 150° C. for 336 hours.

9. The flame-retardant soundproof material for vehicles of claim 1, wherein the urethane resin composition does not contain a flame retardant other than the expandable graphite (C).
